(19) United States
(12) Patent Application Publication
(10) Pub. No.: US 2014/0282517 A1
(43) Pub. Date: Sep. 18, 2014

(54) APPLYING AND REMOVING APPROPRIATE FILE OVERLAYS DURING LIVE APPLICATION MOBILITY

(71) Applicant: International Business Machines Corporation, Armonk, NY (US)

(72) Inventors: J. Mark McConaughy, Austin, TX (US); Khalid Filali-Adib, Austin, TX (US)

(73) Assignee: International Business Machines Corporation, Armonk, NY (US)

(21) Appl. No.: 13/838,653

(22) Filed: Mar. 15, 2013

(51) Int. Cl. G06F 9/50

(52) U.S. Cl. CPC G06F 9/5077
USPC 718/1

(57) ABSTRACT

Provided are techniques for moving, in conjunction with live application mobility, a virtual machine (VM) workload partition (WPAR) on a first logical partition (LPAR) running on a first operating system (OS) to second a LPAR running a second OS, wherein the first OS is a different version than the second OS; the moving comprising, in response to a determination that that the second OS is a newer version of the first OS: determining a set of overlays associated with the WPAR corresponding to the second OS; removing from the WPAR a set of overlays associated with the WPAR corresponding to the first OS; and applying to the WPAR the set of overlays corresponding to the second OS.

### FIELD OF DISCLOSURE

The claimed subject matter relates generally to computing systems and, more specifically, to techniques for applying and removing file overlays during live application mobility

### BACKGROUND OF THE INVENTION

Unlike logical partitions (LPARs), in which computing resources are partitioned with respect to hardware, a virtualized file system is partitioned with respect to software. In addition, although LPARs which may have different operating systems, virtualized file system spaces typically include virtualized operating system (OS) environments within a single instance of an OS. One example of a virtualized file system space, used as an example throughout this Specification, is a workload partition (WPAR). It should be understood that although the claimed subject matter is described with respect to WPARs, the same principles also apply to other types of virtualized file system spaces.

Basically, there are two types of WPARs, system WPARs and application WPARs. Typically, a system WPAR partitions system resources and an application WPAR isolates and executes one or more application processes. The following description is based upon system WPARs. Each WPAR has a regulated share of system resources and may have unique networks and file systems. In addition, each WPAR may have separate administrative and security domains, with each WPAR having a unique root user, regular users and passwords, its own services such as inetd, cron and syslog, and can be stopped and started on its own. A WPAR does not typically share writable file systems with other WPARs or the global system. WPARs share an operating system and may share underlying file systems, real or virtual disk adapters, processors, memory, paging space and a real or virtual network card.

Although WPARs within a particular LPAR share one OS, different WPARs within a LPAR may run different versions of a particular OS. Such a WPAR is called a “versioned” WPAR. A versioned WPAR typically runs an older version of an OS than the global LPAR. The versioned WPAR contains commands, shared libraries, and so on of whatever level of OS it is running. However some commands, such as, but not limited to, device drivers and other kernel extensions, within a versioned WPAR are “overlaid,” which means that the WPAR runs the corresponding command in the global LPAR. Typically, this is necessary to keep certain commands in sync with the kernel on the global LPAR because WPARs do not include their own kernel.

When a file is overlaid, the file is renamed, typically by adding a suffix to the name and the original file, or legacy binary, is replaced by a symbolic link to a copy of the native runtime execution wrapper. Typically, there is one copy of the native execution wrapper for each target binary's directory path. In addition, actions are taken to reflect these changes in data that an install facility uses to track the state of all installed files on the system and references to the original name are replaced by the new name with the added suffix. The wrapper mechanism works as follows: 1) The path of the native library is pre-pended to the LIBPATH parameter; 2) The name of the executable that invoked the wrapper is identified; and 3) A special new “native runtime exec( ) interface” is called to execute the corresponding native binary.

### SUMMARY

As the Inventors herein have realized, there are currently no procedures available for moving, during live application mobility, an workload partition (WPAR) that is running one version of an operating system (OS) on one logical partition (LPAR) to a different LPAR running a more current version of the OS. In addition, there are no techniques available for removing an LPAR that has been migrated in such a fashion back to the original LPAR.

Provided are techniques for moving, in conjunction with live application mobility, a virtual machine (VM) workload partition (WPAR) on a first logical partition (LPAR) running on a first operating system (OS) to second a LPAR running a second OS, wherein the first OS is a different version than the second OS; the moving comprising, in response to a determination that that the second OS is a newer version of the first OS: determining a set of overlays associated with the WPAR corresponding to the second OS; removing from the WPAR a set of overlays associated with the WPAR corresponding to the first OS; and applying to the WPAR the set of overlays corresponding to the second OS. Additional techniques provided include, in response to a determination that the second OS is an older version of the first OS: detecting a halt in the WPAR; and, in response to a detecting a halt, removing from the WPAR a set of overlays associated with the WPAR corresponding to the first OS; and applying to the WPAR the set of overlays corresponding to the second OS.

This summary is not intended as a comprehensive description of the claimed subject matter but, rather, is intended to provide a brief overview of some of the functionality associated therewith. Other systems, methods, functionality, features and advantages of the claimed subject matter will be or will become apparent to one with skill in the art upon examination of the following figures and detailed description.

### BRIEF DESCRIPTION OF THE DRAWINGS

A better understanding of the claimed subject matter can be obtained when the following detailed description of the disclosed embodiments is considered in conjunction with the following figures.

FIG. 1 is a block diagram of a computing system architecture that may implement the claimed subject matter.

FIG. 2 is a block diagram of a workload partition (WPAR) Overlay Manager (OLM), introduced above in FIG. 1, in greater detail.

FIG. 3 is a flowchart of one example of a Move WPAR process that may implement aspects of the claimed subject matter.

FIG. 4 is a flowchart of an Apply Overlays process that may implement aspects of the claimed subject matter.

FIG. 5 is a flowchart of one example of an Overlay File process that may implement aspects of the claimed subject matter.

FIG. 6 is a flowchart of one example of a Remove Overlays process that may implement aspects of the claimed subject matter.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational actions to be performed on the computer, other programmable apparatus or other devices to produce a computer implemented process such that the instructions which execute on the computer or other programmable apparatus provide processes for implementing the functions/acts specified in the flowchart and/or block diagram block or blocks. It should also be understood that, although described with respect to WPARs, the claimed subject matter is equally applicable to other types of virtualized file system spaces.

Turning now to the figures, FIG. 1 is a block diagram of one example of a computing system architecture 100 that may incorporate the claimed subject matter. A computing system 102 includes a central processing unit (CPU) 104, coupled to a monitor 106, a keyboard 108 and a pointing device, or “mouse,” 110, which together facilitate human interaction with elements of architecture 100 and computing system 102. Also included in computing system 102 and attached to CPU 104 are computer-readable storage mediums (CRSMs), specifically a CRSM_{—}1 111, a CRSM_{—}2 112 and a CRSM_{—}3 113. Each of CRSMs 111-113 may either be incorporated into client system 102, i.e. an internal device, or attached externally to CPU 104 by means of various, commonly available connection devices such as but not limited to, a universal serial bus (USB) port (not shown).

CRSM_{—}1 111 is illustrated storing two (2) logical partitions (LPARs), i.e. an LPAR_{—}1 121 and an LPAR_{—}2 122. LPAR_{—}1 121 is illustrated with a workload partition (WPAR), i.e. a WPAR_{—}1 126, and an operating system (OS), i.e. OS_{—}1 131. LPAR_{—}2 122 is illustrated with a WPAR_{—}2 127 and an OS_{—}2 132. In the following examples, OS_{—}1 131 is an older version of OS_{—}2 132 and the disclosed subject matter describes how an WPAR such as WPAR_{—}1 126 may be migrated from LPAR_{—}1 121 and OS_{—}1 131 to LPAR_{—}2 122 and OS_{—}2 132 (see 200 and 250, FIGS. 3 and 4). In addition, the disclosed subject matter describes how a WPAR, such as WPAR_{—}2 127, which has already been migrated from LPAR_{—}1 121 to LPAR_{—}2 122 may be un-migrated back to LPAR_{—}1 121 (see 300, FIG. 5). WPAR_{—}1 126 and WPAR_{—}2 127 each include a overlaid file system, i.e. an OLFS_{—}1 128 and an OLFS_{—}2 129, respectively.

Also stored on CRSM_{—}1 111 for execution on one or more processors (not shown) of computing system 102 is an WPAR Overlay Manager (OLM) 136. In the following examples, WPAR OLM 136 is configured to implement the claimed subject matter. As explained above, WPAR_{—}1 121, once migrated, and WPAR_{—}2 122 are versioned WPARs, i.e. running a less current version of an OS than the LPAR to which they are installed.

Computing system 102 is also coupled to the Internet 140), which is in turn coupled to two (2) other computing systems, i.e. a client 142 and a server 144. Although in this example, computing system 102 and computing systems 142 and 144 are communicatively coupled via the Internet 140, they could also be coupled through any number of communication mediums such as, but not limited to, a local area network (LAN) (not shown). Computing devices 142 and 144 are used as examples of resources that may be available to computing system 102 and serve as potential access points to computing system 102. It should be understood that although illustrated only on one computing system and CRSM, LPARs 121 and 122, WPARs 126 and 127 and WPAR OLM 136 may reside on different CRSMs and even different computing systems such as CRSMs 112 and 113, client 142 and server 144. It also should be noted that a typical computing system would typically include many addition elements, but for the sake of simplicity only a few are shown.

FIG. 2 is a block diagram of WPAR OLM 136, introduced above in FIG. 1, in greater detail. WPAR OLM 136 includes an input/output (I/O) module 150, a data module 152, an overlay module 154 and operation logic 156. Although there may be other components of WPAR OLM 136, for the sake of simplicity, only components 150, 152, 154 and 156 are illustrated and described. For the sake of the following examples, logic associated with WPAR OLM 136 is assumed to execute on one or more processors (not shown) of computing system 102 (FIG. 1) and to be stored on CRSM_{—}1 111 (FIG. 1). It should be understood that the claimed subject matter can be implemented in many types of computing systems and data storage structures but, for the sake of simplicity, is described only in terms of computing system 102 (FIG. 1) and system architecture 100 (FIG. 1). Further, the representation of WPAR OLM 136 in FIG. 2 is a logical model. In other words, components 150, 152, 154 and 156 may be stored in the same or separates files and loaded and/or executed within computing system 102 and architecture 100 either as a single system or as separate processes interacting via any available inter process communication (IPC) techniques.

I/O module 150 handles any communication WPAR OLM 136 has with other components of computing system 102, architecture 100 and an administrator or user. Data module 152 is a data repository for information and parameters that WPAR OLM 136 requires during operation. Examples of the types of information stored in data module 142 include LPAR data 160, WPAR data 162, version data 164, fileset data 166 and option data 168.

LPAR data 160 stores information relating to established LPARs such as LPAR_{—}1 121 (FIG. 1) and LPAR_{—}2 122 (FIG. 1), including, but not limited to, information on the particular OS running on each. WPAR data 162 stores information relating to established WPARs such as WPARs 126 and 127, including, but not limited to, various resources that may be allocated to each of WPAR 126 and 127. Version data 164 stores information on the specific version of OSs 131 and 132 that each of LPARs 126 and 127 is currently executing. Fileset data 166 stores information about the filesets installed in each of WPARs 126 and 127 as well as the specific filesets that have been overlaid in accordance with the claimed subject matter. Option data 168 stores user and administrative operating parameters that may control the operation of WPAR OLM 136.

Overlay module 154 stores logic responsible for installing the appropriate filesets in versioned WPARs such as WPAR 121 in accordance with the claimed subject matter. To determine appropriate filesets, overlay module 154, also determines the differences between an OS from which and to a particular WPAR is migrating. Operation logic 156 stores logic associated with implementation of the claimed subject matter as well as logic responsible for the typical logic associated with the installation and updating of WPARs such as WPARs 126 and 127. Components 152, 154, 156, 160, 162, 164, 166 and 168 are described in more detail below in conjunction with FIGS. 3-6.

FIG. 3 is a flowchart of one example of a Move WPAR process 200 that may implement aspects of the claimed subject matter. In this example, process 200 is associated with logic stored on CRSM_{—}1 111 (FIG. 1) in conjunction with WPAR OLM 136 (FIGS. 1 and 2) and executed on one or more processors (not shown) of CPU 104 (FIG. 1) of computing system 102 (FIG. 1). In the following example, WPAR_{—}1 126 (FIG. 1) is moved from LPAR_{—}1 121 (FIG. 1), which is referred to as the “departure” LPAR and is running on OS_{—}1 131 (FIG. 1), to LPAR_{—}2 122 (FIG. 1), which referred to as the “arrival” LPAR and is running OS_{—}2 32 (FIG. 1), which is a different, newer version OS than OS_{—}1 131.

Process 200 begins in a “Begin Move WPAR” block 202 and proceeds immediately to a “Determine OSs” block 204. During processing associated with block 204, a determination is made as to the specific versions of the OS_{—}1 131, from which WPAR_{—}1 126 is being moved, and OS_{—}2 132, to which WPAR_{—}1 126 is being moved. Such a determination may be based upon information stored in conjunction with WPAR OLM 136 (see 160, FIG. 2) or, in the alternative, based upon queries to the various OSs 131 and 132 involved. During processing associated with a “To Same OS?” block 206, a determination is made as to whether or not OS_{—}2 132 is the save version as OS_{—}1 131. If so, control proceeds to a “Move WPAR” block 208. During processing associated with block 208, standard procedures for moving an WPAR are implemented.

If, during processing associated with block 206, a determination is made that the OS_{—}2 132 is not the same version of OS as OS_{—}1 131, control proceeds to a “Start Move WPAR” block 210. During processing associated with block 210, the moving process, which takes while applications are active on the departure side is started. During processing associated with an “Apply Overlays” block 212, files, registers and parameters associated with WPAR_{—}1 126, including any files that have been overlaid, are migrated to LPAR_{—}2 122 in accordance with know and any yet to be developed migration procedures. When moving WPARs in accordance with live application mobility, i.e. when applications running in conjunction with the WPAR being moved are not shut down, there is a short period of time after starting the WPAR on in the arrival LPAR when all the processes on the departure side are frozen. While frozen, application data such as open files, memory content and so on are captured and transferred to the arrival LPAR. This provides a window of opportunity when none of the processes of the WPAR are running, thus install activity may take place without a chance a WPAR is updating software vital product data (SWVPD). File systems of the WPAR are still accessible from the departure side so overlays can be applied during this time period. Essentially, the timing enables overlays to be applied in an atomic manner relative to any other activity on the system. When processes are restarted on the arrival side and begin accessing the file systems, the overlay are in place during processing associated with a “Finish Move WPAR” block 214.

During processing associated with a “To Previous OS?” block 216, a determination is made as to whether or not OS_{—}2 132 is an older version of OS_{—}1 131 that corresponds to WPAR_{—}1 126 prior to any overlays being applied. For example, OS_{—}2 132 would be a previous version of OS_{—}1 131, if OS_{—}2 132 is a less current version of OS_{—}1 131, WPAR_{—}1 126 is native to the OS of LPAR_{—}2 122 and had previously been moved from LPAR_{—}1 121, or another LPAR (not shown) with the same version of OS as OS_{—}2 132, to LPAR_{—}2 122.

If a determination is made that OS_{—}1 131 is a previous version of OS_{—}2 132, control proceeds to a “Wait for Stoppage” block 218. During processing associated with block 218, Completion of the move of WPAR_{—}1 126 waits for WPAR_{—}1 126 to be halted. The freeze period employed during overlaying files (see 208) cannot be used to remove overlaid files because overlaid files typically need to stay in place until WPAR_{—}1 126 is completely shut down on the departure side. If overlays are removed before WPAR_{—}1 126 has un-configured devices on the departure side, un-configure procedures may fail. Therefore, overlays are left in place until a stoppage and WPAR_{—}1 126 becomes active as a native WPAR on the arrival side. During processing associated with a “Remove Overlays” block 220, any overlays installed in WPAR_{—}1 126 are removed. During processing associated with a “Restart WPAR” block 222, WPAR_{—}1 126 is restarted in the arrival LPAR_{—}2 122.

Finally, if during processing associated with block 216 a determination is made as that OS_{—}2 132 is not a previous version of OS_{—}1 131, or, during processing associated with block 222. WPAR_{—}1 126 has been restarted, control proceeds to an “End Move WPAR” block 229 in which process 200 is complete.

FIG. 4 is a flowchart of one example of an Apply Overlays process 250 that may implement aspects of the claimed subject matter. Process 250 corresponds to Apply Overlays block 208 (FIG. 3) of Move WPAR process 200 (FIG. 3). Like process 200, in this example, process 250 is associated with logic stored on CRSM_{—}1 111 (FIG. 1) in conjunction with WPAR OLM 136 (FIG. 1) and executed on one or more processors (not shown) of CPU 104 (FIG. 1) of computing system 102 (FIG. 1).

Process 250 begins in a “Begin Apply Overlays” block 252 and proceeds immediately to a “Determine OS” block 254. During processing associated with block 254, the OS of the arrival LPAR, which in this example is OS_{—}2 132 of LPAR_{—}2 122, is ascertained, typically based upon stored information (see 160, FIG. 2) or querying the appropriate OS. During processing associated with a “Overlays (OLs) Needed?” block 256 a determination is made as to whether or not any overlay are needed for the current move. If so, control proceeds to a “Retrieve OL Info” block 258 during which information that lists the specific overlay required is gathered. Typically, this information is stored in conjunction with WPAR OLM 136 (see 160, 162, 164 and 166, FIG. 2). During processing associated with a “Remove Overlays” block 260, old overlays are removed (see 350, FIG. 6).

During processing associated with a “Get Next File in OL List” block 262, the name of a file yet to be processed is selected from the OL info retrieved during processing associated with block 258. During processing associated with an “Overlay Files” block 264, the file whose name was selected during processing associated with block 262 is overlaid (see 300, FIG. 5). During processing associated with a “More Files?” block 266, a determination is made as to whether or not there are files listed in the info retrieved during processing associated with block 258 that have yet to be processed. If so, control returns to block 262, the next name in the list is selected and processing continues as described above. If not, or if a determination has been made during processing associated with block 256 that overlays were not needed, control proceeds to an “End Apply Overlays” block 269 during which process 250 is complete.

FIG. 5 is a flowchart of one example of an Overlay File process 300 that may implement aspects of the claimed subject matter. Process 300 corresponds to Overlay File block 262 (FIG. 4) of Apply Overlays process 250 (FIG. 4). Like processes 200 and 250, in this example, process 300 is associated with logic stored on CRSM_{—}1 111 (FIG. 1) in conjunction with WPAR OLM 136 (FIG. 1) and executed on one or more processors (not shown) of CPU 104 (FIG. 1) of computing system 102 (FIG. 1).

Process 300 begins in a “Begin Overlay File” block 302 and proceeds immediately to a “Fileset (FS) Present?” block 304. During processing associated with block 304, a determination is made as to whether or not the file being processed (see 260, FIG. 4) is a member of a fileset that is already present in the WPAR being processed. As explained above, information on the files of the WPAR (see 162 and 166, FIG. 2) includes the fileset to which the file belongs. It should also be noted that, although not illustrated in this particular diagram, if a particular file is not present and not part of a mandatory fileset, the file is not needed and therefore no overlay is created.

If the fileset is present, control proceeds to a “Save Original File” block 306. During processing associated with block 306, the file that is already installed is renamed, typically by adding a suffix to the original name. In addition, references to the file in any files that track the file for administrative purposes are also modified to reflect the new name so that, when the original file is to be updated, the original file is updated rather than the file identified by the link. If, during processing associated with block 304 a determination is made that the fileset to which the file belongs is not present, control proceeds to an “FS Mandatory?” block 308. During processing associated with block 308, a determination is made as to whether or not the fileset that was determined not to be present during processing associated with block 304 is a required fileset. If so, or if during processing associated with block 306 the original file has been saved under a new name, control proceeds to a “File Binary?” block 310. During processing associated with block 310, a determination is made as to whether or not the file being processed is binary or not, i.e. a script file. If the file is binary, control proceeds to a “Create Link to Runtime Execution Wrapper (RTEW)” block 312. During processing associated with block 312, a link to the RTEW is generated, having the original name of the file. If a determination is made, during processing associated with block 310, that the file being processed in not binary, then control proceeds to “Create Link to Global Script File (GSF)?” block 314. During processing associated with block 314, a link is created to the corresponding global script file. It should be noted that a script file does not need to employ a RTEW so the link points directly to the corresponding GSF of the native OS.

In addition, if a determination was made during processing associated with block 304, that the file was not present and during processing associated with block 308 that the file was not mandatory, then the original file did not need to be renamed because the file was not in memory. In this manner, files that do not need to be installed and will never be used are not installed and do not consume computing resources.

Once a link to a RTEW has been created during processing associated with block 312, a link to a GSF created during block 314 or a determination is made that a fileset is not mandatory during processing associated with block 308, control proceeds to an “End Generate Overlay” block 319 during which process 300 is complete. Files handled in accordance with the disclosed technology eliminate work WPAR OLM 136 would typically need to perform because original files are not installed and thus do not need to be overlaid during updates. Concerns that overlaid files are over-written are also eliminated. In addition, any updates to files in the LPAR_{—}2 122 are automatically applied because the WPAR_{—}1 126 will point to the updated binaries and scripts as soon as they are placed in the LPAR_{—}2 122.

FIG. 6 is a flowchart of one example of a Remove Overlays process 350 that may implement aspects of the claimed subject matter. Process 350 corresponds to Remove Overlays block 216 (FIG. 3) of Move WPAR process 200 (FIG. 3). Like processes 200, 250 and 300, in this example, process 350 is associated with logic stored on CRSM_{—}1 111 (FIG. 1) in conjunction with WPAR OLM 136 (FIG. 1) and executed on one or more processors (not shown) of CPU 104 (FIG. 1) of computing system 102 (FIG. 1).

Process 350 begins in a “Begin Remove Overlays” block 352 and proceeds immediately to a “Retrieve overlay (OL) Data” block 354. During processing associated with block 354, overlay data that lists the particular overlaid files in WPAR_{—}1 126 are retrieved from memory (see 162, 166, FIG. 2). During processing associated with a “Remove Symbolic Links” block 356, symbolic links (see 312, 314. FIG. 5) that have replaced the listed files are removed from WPAR_{—}1 126. During processing associated with a “Replace Original Files” block 358, the files that were saved by renaming during the overlaying (see 306, FIG. 5) are returned to their original names thereby restoring the original files into their original locations. During processing associated with an “Update File Data” block 360, system files that track changes and keep track of file overlays are updated. Finally, control proceeds to an “End Remove Overlays” block 369 during which process 350 is complete.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

1-6. (canceled)

7. A apparatus, comprising:
a processor,
a non-transitory computer-readable storage medium (CRSM); and
logic, stored on the CRSM and executed on the processor, for:
moving, in conjunction with live application mobility, a virtual machine (VM) workload partition (WPAR) on a first logical partition (LPAR) running on a first operating system (OS) to second a LPAR running a second OS, wherein the first OS is a different version than the second OS; the moving comprising, in response to a determination that that the second OS is a newer version of the first OS:
determining a set of overlays associated with the WPAR corresponding to the second OS; and
removing from the WPAR a set of overlays associated with the WPAR corresponding to the first OS; and
applying to the WPAR the set of overlays corresponding to the second OS.

8. The apparatus of claim 7, the logic further comprising logic for, in response to a determination that that the second OS is an older version of the first OS:
detecting a halt in the WPAR; and, in response to a detecting a halt,
removing from the WPAR a set of overlays associated with the WPAR corresponding to the first OS; and
applying to the WPAR the set of overlays corresponding to the second OS.

9. The apparatus of claim 8, the logic further comprising logic for restarting the WPAR.

10. The apparatus of claim 7, the logic further comprising logic for:
detecting that the second executable is a binary file;
generating a link that references a runtime execution wrapper corresponding the second executable; and
installing the link in the WPAR, wherein the dynamically calling comprises calling the second executable via the link.

11. The apparatus of claim 7, the logic for generating further comprising logic for:
detecting that the second executable is a global script file (GSF);
generating a link that references the GSF; and
installing the link in the WPAR, wherein the dynamically calling comprises calling the second executable via the link.

12. The apparatus of claim 7, wherein the first executable is one of a group consisting of:
a command;
a library;
a script; and
a binary file.

13. A computer programming product, comprising:
a processor;
a non-transitory computer-readable storage medium (CRSM); and
logic, stored on the CRSM and executed on the processor, for:
moving, in conjunction with live application mobility, a virtual machine (VM) workload partition (WPAR) on a first logical partition (LPAR) running on a first operating system (OS) to second a LPAR running a second OS, wherein the first OS is a different version than the second OS; the moving comprising, in response to a determination that that the second OS is a newer version of the first OS:
determining a set of overlays associated with the WPAR corresponding to the second OS; and
removing from the WPAR a set of overlays associated with the WPAR corresponding to the first OS; and
applying to the WPAR the set of overlays corresponding to the second OS.

14. The computer programming product of claim 13, the logic further comprising logic for, in response to a determination that that the second OS is an older version of the first OS:
detecting a halt in the WPAR; and, in response to a detecting a halt,
removing from the WPAR a set of overlays associated with the WPAR corresponding to the first OS; and
applying to the WPAR the set of overlays corresponding to the second OS.

15. The computer programming product of claim 14, the logic further comprising logic for restarting the WPAR.

16. The computer programming product of claim 13, the logic further comprising logic for:
detecting that the second executable is a binary file;
generating a link that references a runtime execution wrapper corresponding the second executable; and
installing the link in the WPAR, wherein the dynamically calling comprises calling the second executable via the link.

17. The computer programming product of claim 13, the logic for generating further comprising logic for:
detecting that the second executable is a global script file (GSF);
generating a link that references the GSF; and
installing the link in the WPAR, wherein the dynamically calling comprises calling the second executable via the link.

18. The computer programming product of claim 13, wherein the first executable is one of a group consisting of:
a command;
a library;
a script; and
a binary file.

19. A fileset overlay manager, comprising:
a processor;
a non-transitory computer-readable storage medium (CRSM); and
logic, stored on the CRSM and executed on the processor, for:
moving, in conjunction with live application mobility, a virtual machine (VM) workload partition (WPAR) on a first logical partition (LPAR) running on a first operating system (OS) to second a LPAR running a second OS, wherein the first OS is a different version than the second OS; the moving comprising, in response to a determination that that the second OS is a newer version of the first OS:
determining a set of overlays associated with the WPAR corresponding to the second OS; and
removing from the WPAR a set of overlays associated with the WPAR corresponding to the first OS; and
applying to the WPAR the set of overlays corresponding to the second OS.

20. The fileset overlay manager of claim 19, the logic further comprising logic for, in response to a determination that that the second OS is an older version of the first OS:
detecting a halt in the WPAR; and, in response to a detecting a halt,
removing from the WPAR a set of overlays associated with the WPAR corresponding to the first OS; and
applying to the WPAR the set of overlays corresponding to the second OS.

21. The fileset overlay manager of claim 20, the logic further comprising logic for restarting the WPAR.

22. The fileset overlay manager of claim 19, the logic further comprising logic for:
detecting that the second executable is a binary file;
generating a link that references a runtime execution wrapper corresponding the second executable; and
installing the link in the WPAR, wherein the dynamically calling comprises calling the second executable via the link.

23. The fileset overlay manager of claim 19, the logic for generating further comprising logic for:
detecting that the second executable is a global script file (GSF);
generating a link that references the GSF; and
installing the link in the WPAR, wherein the dynamically calling comprises calling the second executable via the link.

24. The fileset overlay manager of claim 19, wherein the first executable is one of a group consisting of:
a command;
a library;
a script; and
a binary file.
